(19) United States
(12) Patent Application Publication
(10) Pub. No.: US 2017/0248970 A1
(43) Pub. Date: Aug. 31, 2017

(54) PERSONAL FAN DRONE

(71) Applicant: Razmik Karabed, San Jose, CA (US)

(72) Inventor: Razmik Karabed, San Jose, CA (US)

(21) Appl. No.: 15/443,355

(22) Filed: Feb. 27, 2017

Related U.S. Application Data
(60) Provisional application No. 62/300,872, filed on Feb. 28, 2016.

(51) Int. Cl. G05D 1/10; F04D 25/08; G08G 5/04; B64C 39/02; G05D 1/00; G05D 1/04

(52) U.S. Cl. CPC G05D 1/102; G05D 1/0011; G05D 1/042; G08G 5/045; B64C 39/024; F04D 25/088; B64C 2201/146; B64C 2201/12

(57) ABSTRACT

The present invention relates generally to systems for individualizing ventilation, it relates particularly to personal fan drones, and more particularly to providing a mobile fan that follows its user. In one aspect, a drone is utilized to provide individualized ventilation to a user. In one embodiment the drone has a Flight Control System, FCS, which operates the motors of a drone so that the drone behaves as a ceiling fan. In addition, a measuring device provides the FCS information for flying the drone on a holding position over a user. In another embodiment, a measuring device provides the FCS information related to avoiding obstacles. In yet another embodiment, a transmitter and a receiver communicate user's requests to the FCS.

### CROSS-REFERENCE TO RELATED APPLICATIONS

This application claims the benefit of priority to U.S. provisional patent application No. 62/300,872, filed Feb. 28, 2016, the contents of which are herein incorporated by reference.

### BACKGROUND OF THE INVENTION

1) Field of the Invention

The present invention relates generally to drones, relates particularly to personal fan drones, and more particularly to drones providing a current of air for cooling or ventilation; even more particularly to providing a mobile fan that follows its user.

2) Description of Prior Art and Related Information

How many times have two people been in a room with a ceiling fan, wherein one wants more airflow and the other wants less to no airflow? Most assuredly, every couple has experienced this.

Besides reaching a compromise, there is no other viable solution for resolving this conflict. Therefore there is a need for more personalized solution to ventilation with respect to airflow.

### SUMMARY OF THE INVENTION

In view of the foregoing, the present invention is directed to a system for individualizing ventilation with respect to airflow.

In accordance with one aspect of the invention, a drone is utilized to generate a current of air for fanning or ventilation.

In accordance with another aspect of the invention, a Flight Control System, FCS, is used to position and maintain a drone overhead.

In accordance with another aspect of the invention, a tracking system is used to maintain a drone above a user while he/she moves around a room or from one room to another.

In accordance with one embodiment of the invention a drone with six motors is used. In this embodiment the drone acts as a ceiling fan.

In accordance with another embodiment of the invention, a drone with six motors is used. The drone has a Flight Control System, FCS, configured to operate the motors of the drone so that the drone behaves as a ceiling fan. In addition, a measuring device is configured to provide the FCS information for flying the drone on a holding position over a stationary user. The measuring device comprises of at least one of the following sensors: image, sound, IR, ultrasonic, gyro, and accelerometer.

In accordance with another embodiment of the invention, a hexacopter having a FCS is used. “Hexacopter” is a drone with six motors. Additionally, a measuring device is configured to provide the FCS information for tracking a non-stationary user. The measuring device comprises of at least one of the following sensors: image, sound, IR, ultrasonic, gyro, and accelerometer.

In accordance with another embodiment of the invention, in order to avoid obstacles during tracking, a measuring device is configured to generate related information and to provide the information to a FCS.

In accordance with yet another embodiment of the invention, a Radio Control (RC) Transmitter/Receiver, (TX/RX) pair is used associated with the drone having a FCS. The RX is configured to communicate user requests to the FCS. One request may be to turn on the motors; other requests may be related to flying the drone from an initial position to the where the user is.

### BRIEF DESCRIPTION OF THE DRAWINGS

Some embodiments of the present invention are illustrated as an example and are not limited by the figures of the accompanying drawings, in which like references may indicate similar elements.

FIG. 1 depicts the first embodiment of the personal fan drone;

FIG. 2 depicts a block diagram illustrating the flight control system of the first embodiment of the personal fan drone;

FIG. 3 illustrates the first embodiment providing individualized airflow in a room;

FIG. 4 depicts the second and the third embodiments of the personal fan drone;

FIG. 5 depicts a block diagram illustrating the flight control system and the measuring device of the second and the third embodiments of the personal fan drone;

FIG. 6 depicts the fourth embodiment of the personal fan drone;

FIG. 7 depicts a block diagram illustrating the RC transmitter/receiver pair of the fourth embodiment of the personal fan drone.

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF EXEMPLARY EMBODIMENTS OF THE INVENTION

In the disclosure that follows, in the interest of clarity, not all features of actual implementations are described. It will of course be appreciated that in the development of any such actual implementation, as in any such project, numerous engineering and technical decisions must be made to achieve the developers' specific goals and sub-goals (e.g., compliance with system, technical, and practical constraints), which will vary from one implementation to another. Moreover, attention will necessarily be paid to proper design and engineering practices for the environment in question. It will be appreciated that such development efforts could be complex and time-consuming, outside the knowledge base of typical laymen, but would nevertheless be a routine undertaking for those of ordinary skill in the relevant fields.

### First Embodiment

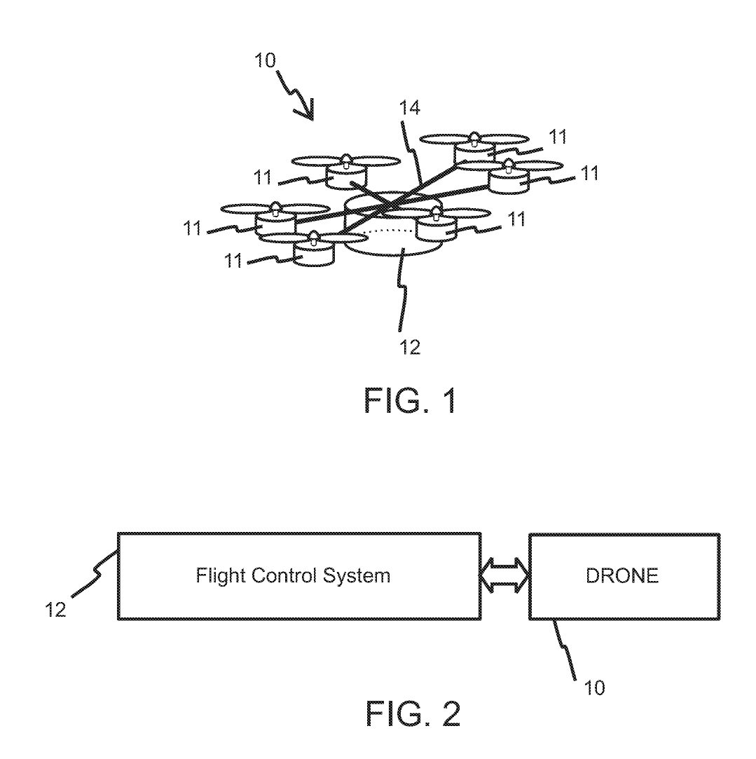

Referring to FIG. 1 a first embodiment of the personal fan drone is shown. FIG. 1 illustrates a drone 10 having six motors 11. The motors 11 are affixed to a frame 14. The drone 10 has a flight control system, FCS, 12.

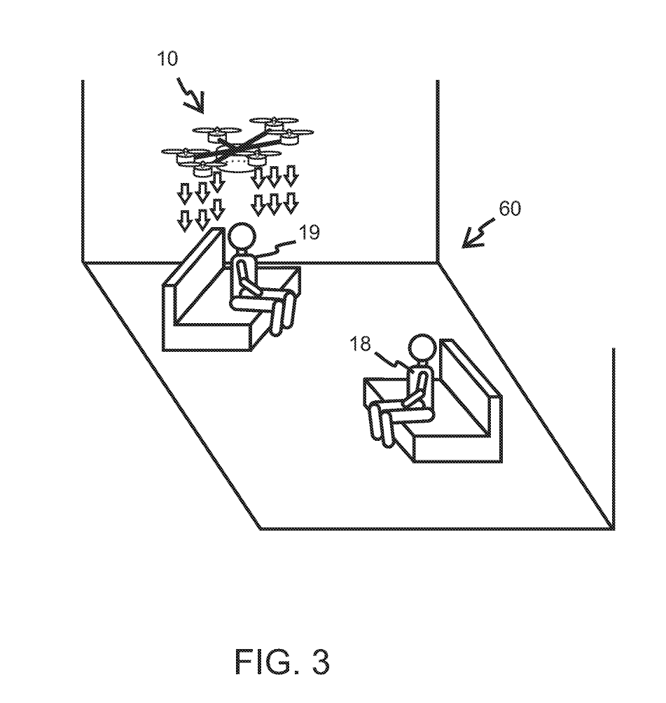

The FCS 12 of the personal fan drones 10 of the first embodiment flies the drone 10 to a selected height, and it keeps the drone 10 hovering in a somewhat stationary manner. Referring to FIG. 3, there are two people 18 and 19 in a room 60. We see the personal fan drone 10 provides an individualized airflow for the person 19. If the room 60 had a ceiling fan then the airflow of the fan would have generated a similar cooling and ventilation environment for both people 18 and 19.

FIG. 2 depicts a block diagram showing the interaction between the FCS 12 and the drone 10. The FCS 12 is able to move the drone 10 around by controlling the motors 11.

### Second Embodiment

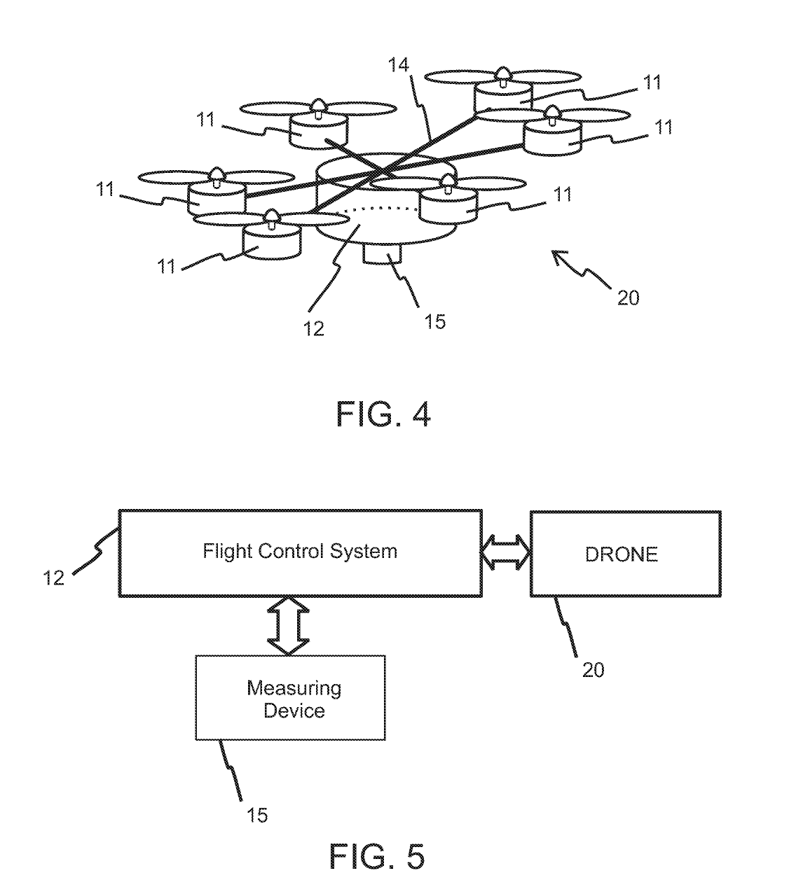

Referring to FIG. 4, a second embodiment of the personal fan drone is shown. FIG. 4 shows a drone 20 having six motors 11. The motors 11 are affixed to a frame 14. The drone 20 has a flight control system, FCS 12.

The FCS 12 of the personal fan drones 20 of the second embodiment flies the drone 20 to a selected height, and it keeps the drone 20 hovering in a somewhat stationary manner. In this position, the personal fan drone 20 acts as a personal fan for anyone standing or sitting under it.

As shown in FIG. 4, the second embodiment further comprises a measuring device 15. The measuring device 15 may be physically present on the drone 20 under the FCS 12. The measuring device 15 is configured to provide the FCS 12 information for stabilizing the drone 20 over a stationary user. The measuring device 15 comprises of at least one of the following sensors: image, sound, IR, ultrasonic, pressure/force, gyro, and accelerometer.

Without the measuring device 15, the FCS 12 cannot prevent the drone 20 from drifting from an initial position due to airflow or another disturbance.

The FCS 12 may use any of the following methods in order to fly the drone 20 on a stable holding position over a stationary user.

Briefly, with image processing an image sensor data, the FCS 12 may find the direction from the drone 20 toward the stationary user. Then the FCS 12 may make adjustments in the drone 20 position to keep it stable against airflow and other disturbances.

With processing an IR sensor data or an ultrasonic sensor data, the FCS 12 may evaluate the distance to the stationary user and make adjustments in the drone 20 position to keep it stable.

With processing a GPS, a gyro, a compass, a barometer, or an accelerometer data, the FCS 12 may evaluate small changes in the drone 20 position and make adjustments in the drone 20 position to keep it stable.

Regarding a pressure/force sensor of a joystick variety, when one end of a string is tied to the sensor and the other end is held by the stationary user, then relative position changes between the drone 20 and the stationary user may be detected by the FCS 12 and may be used to stabilize the drone 20 position with respect to the user.

FIG. 5 depicts a block diagram explaining the interaction among the FCS 12, the drone 20 and the measuring device 15. Measurements by the measuring device 15 are available to the FCS 12. The FCS 12 is able to keep the drone 20 stable by controlling the motors 11.

### Third Embodiment

Next a third embodiment of the personal fan drone is explained. This embodiment generalizes the second embodiment in that the second embodiment illustrates the invention for a stationary user, and the third embodiment illustrates the invention for a non-stationary user. The two embodiments mostly differ in the way they process data from their measuring devices. To describe the third embodiment, we will use FIGS. 4 and 5 of the second embodiment.

FIG. 4 shows a drone 20 having six motors 11. The motors 11 are affixed to a frame 14. The drone 20 has a flight control system, FCS, 12.

As shown in FIG. 4, the third embodiment further comprises a measuring device 15. The measuring device 15 is configured to provide the FCS 12 information for tracking and covering a non-stationary user with the drone 20. Further, the measuring device 15 is configured to provide the FCS 12 information about any obstacles along the tracing trajectory, especially when going from one room into another.

The FCS 12 of the personal fan drones 20 of the third embodiment flies the drone 20 to a selected height, and it flies the drone 20 tracking the non-stationary user while the drone 20 acts as a personal fan. The FCS 12 uses information on tracking from the measuring device 15 to follow the non-stationary user. And the FCS 12 uses information on obstacles from the measuring device 15 to avoid collision with the obstacles during tracking. The measuring device 15 comprises of at least one of the following: image sensor, sound detector, speech recognition system, proximity sensor, IR sensor, ultrasonic sensor, pressure/force sensor, gyro and accelerometer.

In this embodiment, the FCS 12 uses a proximity sensor of the measuring device 15 to detect objects in the drone 20 surroundings that are closer than a selected distance. Once an object is detected, the FCS 12 controls the motors 11 to steer the drone 20 in order to avoid collision. For example if a door head to too low, then the FCS 12 would lower the drone 20 in order to pass under the door head while tracking the non-stationary user.

In order to successfully track the non-stationary user, the FCS 12 may use any of the earlier given methods that utilize sensors belonging to the measuring device 15.

FIG. 5 depicts a block diagram explaining the interaction among the FCS 12, the drone 20 and the measuring device 15. Measurements by the measuring device 15 are available to the FCS 12. The FCS 12 is able to keep the drone 20 tracking a non-stationary user by controlling the motors 11.

### Fourth Embodiment

A fourth embodiment is presented next. The fourth embodiment is the third embodiment equipped with a RC transmitter/receiver (TX/RX) pair.

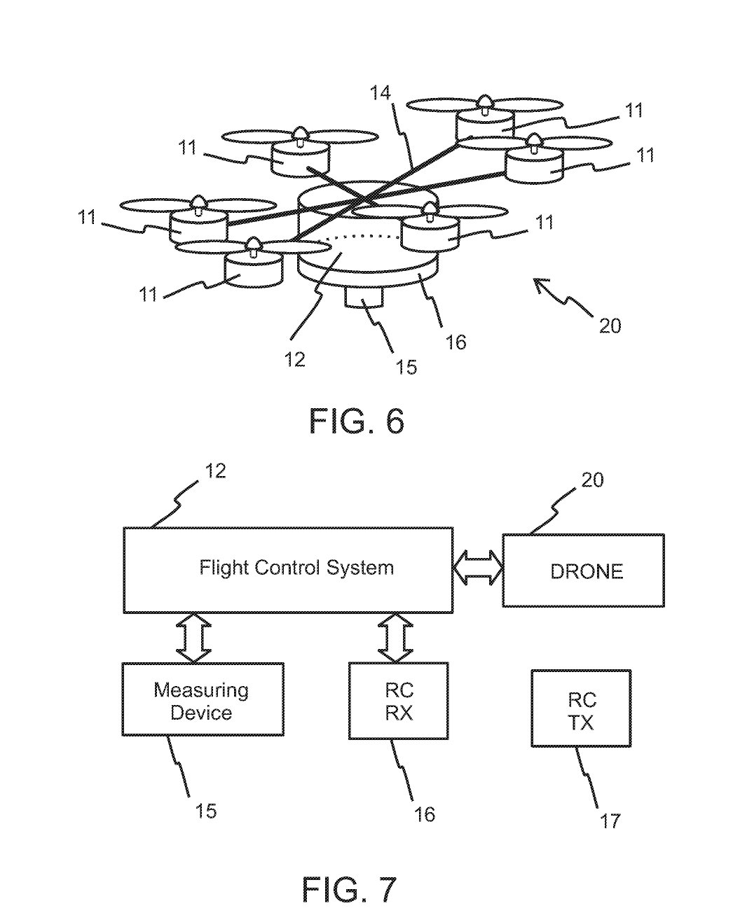

FIG. 6 shows the personal fan drone 20 of the third embodiment equipped with a RC receiver (RX) 16.

Referring to the block diagram of FIG. 7, a user may send requests to the receiver (RX) 16 with the transmitter (TX) 17. In turn, the receiver (RX) 16 sends the user requests to the FCS 12 of the drone 20.

One request may be to turn on the motors 11; other requests may be related to flying the drone 20 from an initial position to the where the user is. Yet another request may be to move the drone somewhat to the right, left, front or back of a user, instead of being directly on top of the user.

In addition to the receiver (RX) 16 and the transmitter (TX) 17 pair, the FCS 12 may use a sound detector and a speech recognition system of the measuring devices 15 to recognize the user's voice request.

Although we have used hexacopter, the invention is not limited to drones with 6 motors. The hexacopter is used as an example only.

In all the embodiments the strength of the airflow may be adjusted by changing the height of the drone over the user. The higher the drone moves over the user the weaker the airflow becomes, and vice versa. A user may use a transmitter/receiver pair to vary the height of the flight of the drone. Another way to vary the strength of the airflow is to vary drone weight. The heavier the drone becomes the faster the motors need to run and hence the stronger the airflow becomes, and vice versa. A user may control the strength of airflow by utilizing an adjustable weight drone.

The personal fan drones of this invention may carry a heat source in order to raise the temperature of their airflow. A user may turn on and off the heat source as desired. The heat source may use a battery or a power supply that is plugged in a wall power outlet and is connected to the heat source using a long cable.

What is claimed is:

1. A personal fan drone comprising a drone having a flight control system configured to have the drone hovering at a selected height providing an individualized airflow to a stationary user.

2. The personal fan drone of claim 1, where a measuring device is added and is configured to provide the flight control system information for flying the drone over the stationary user on a stabilized holding position.

3. The personal fan drone of claim 2, where the measuring device comprises of at least one of the following: an image sensor, a sound detector, a speech recognition system, a proximity sensor, an IR sensor, an ultrasonic sensor, a pressure/force sensor, a gyro and an accelerometer.

4. A personal fan drone comprising: a drone; a measuring device configured to generate information related to the location of a user; and a flight control system configured to receive from the measuring device the information related to the location of the user, and it is further configured to fly the drone over the user and to follow the user's movements; whereby the drone provides an individualized airflow to the user.

5. The personal fan drone of claim 4, wherein the measuring device is further configured to generate information related to objects that are closer than a selected distance from the drone, and wherein the flight control system is further configured to receive from the measuring device the information related to the objects that are closer than a selected distance from the drone, and the flight control system is further configured to avoid collision with the objects.

6. The personal fan drone of claim 1, where a pair of transmitter/receiver is added to inform the flight control system about a request by the user.

7. The personal fan drone of claim 4, where a pair of transmitter/receiver is added to inform the flight control system about a request by the user.
